(19) United States
(12) Patent Application Publication
(10) Pub. No.: US 2010/0157637 A1
(43) Pub. Date: Jun. 24, 2010

(54) GREEN-ENERGY POWER GENERATOR FOR ELECTRICAL DISCHARGE MACHINE

(75) Inventors: Der-Shuen Chen, Taichung (TW); Jui-Kuan Lin, Taichung City (TW); Chao-Chuang Mai, Taichung County (TW); Chen-Huei Kuo, Taichung County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Industrial Technology Research Institute, Hsin-Chu (TW)

(21) Appl. No.: 12/427,426

(22) Filed: Apr. 21, 2009

(30) Foreign Application Priority Data
Dec. 23, 2008 (TW) 097146940

(51) Int. Cl. H02M 7/06; G05F 1/08

(52) U.S. Cl. 363/126; 323/273; 323/282

(57) ABSTRACT

This invention relates a green-energy power generator for electrical discharge machine, which comprise: an alternating current (AC) power supply, an AC-to-DC power converter, a DC-to-DC power converter, a current limiting unit, a time limiting unit, and a control unit. It can reduce the unnecessary energy consumption and achieve the objective of energy saving.

### FIELD OF THE INVENTION

The present invention relates to a green-energy power generator for electrical discharge machine, and more particularly, to a device for electrical discharge machines capable of reducing unnecessary power waste.

### BACKGROUND OF THE INVENTION

Electrical discharge machining (EDM) is a non-traditional method of removing material by a series of rapidly recurring electric arcing discharges between an electrode (the cutting tool) and the workpiece, in the presence of an energetic electric field. Please refer to FIG. 1, which shows a conventional EDM with current limiting resistor. As shown in FIG. 1, the discharging circuit of the EDM is composed of a 220V alternating current (AC) power supply, an alternating current power transformer T2, a bridge rectifier A, a current limiting resistor R2, a diode for reverse current protection D12 and a transistor Q5. Operationally, the input voltage of the 220V alternating current power supply is dropped to about 56V˜70V by the alternating current power transformer T2 and then filtered by the bridge rectifier A for converting the AC input alternating current into an direct current (DC) output of 80V˜100V, and then the DC output is fed to transistor Q5 through the current limiting resistor R2 and the diode D12 for switching on the transistor Q5 and thus amplifying the DC input into a high-voltage DC output, by that electric arc discharging between an electrode and the workpiece can be enabled as soon as the workpiece and the electrode is disposed sufficiently close to each other, and thereafter, is stopped when the transistor is switched off. Accordingly, by the on/off of the transistor Q5, a series of rapidly recurring electric arcing discharges between the electrode and the workpiece can be caused. However, the aforesaid discharging circuit is short in that: Not only the volume of the alternating current power transformer T2 is increasing with the power thereof, but also since the power loss caused by the current limiting resistor R2 is huge as it is equivalent to the product of the resistance of the current limiting resistor R2 and the square of the current, the current limiting resistor R2 used in the discharging circuit should be a current limiting resistor R2 with large Watt that it is a bulky device with heat dissipation problem, and thereby, there is only about 30% of the power inputted to the aforesaid discharging circuit is actually being used in the electrical discharging while the 70% of the input power is wasted by the current limiting resistor R2, so that the power usage efficiency of the aforesaid discharging circuit is poor.

Therefore, it is in need of a green-energy power generator for electrical discharge machine with high power usage efficiency that is capable of reducing unnecessary power waste.

### SUMMARY OF THE INVENTION

The present invention relates to a green-energy power generator for electrical discharge machine with high power usage efficiency that is capable of reducing unnecessary power waste.

In an embodiment, the present invention provides a green-energy power generator for electrical discharge machine, comprising: an alternating current (AC) power supply, for outputting an AC voltage; an AC-to-DC power converter, coupled to the AC power supply for converting the AC voltage into a first DC voltage; a DC-to-DC power converter, coupled to the AC-to-DC power converter for converting the first DC voltage into a second DC voltage while enabling the second DC voltage to drop with the increasing of a load; a current limiting unit, coupled to the DC-to-DC power converter for limiting the size of current to be outputted therefrom; a time limiting unit, coupled to the current limiting unit for limiting the duration of current being outputted therefrom, and thereby, defining a processing time for an electrode upon a workpiece; and a control unit, coupled to the time limiting unit for controlling the on/off of the time limiting unit according to time pulses provided by the control unit.

In another embodiment, the present invention provides a green-energy power generator for electrical discharge machine, comprising: an direct current (DC) power supply, for outputting a first DC voltage; an DC-to-DC power converter, coupled to the DC power supply for converting the first DC voltage into a second DC voltage while enabling the second DC voltage to drop with the increasing of a load; a current limiting unit, coupled to the DC-to-DC power converter for limiting the size of current to be outputted therefrom; a time limiting unit, coupled to the current limiting unit for limiting the duration of current being outputted therefrom, and thereby, defining a processing time for an electrode upon a workpiece; and a control unit, coupled to the time limiting unit for controlling the on/off of the time limiting unit according to time pulses provided by the control unit.

By setting the DC-to-DC power converter in a high-voltage regulation state, it will cause a high-voltage DC ignition to be generated at the beginning of an electrical discharge machining, and after the success of causing the ignition, the output voltage of the DC-to-DC power converter is dropped for reducing unnecessary energy consumption and achieve the objective of energy saving. Moreover, the current limiting unit used in the present invention can be an electric switch that can be control electrically for generating currents of various intensities and thus defining the size of current flowing in the circuit.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 shows a conventional EDM with current limiting resistor.

FIG. 2 is a block diagram showing a green-energy power generator for electrical discharge machine according to an embodiment of the invention.

FIG. 3 is a block diagram showing a green-energy power generator for electrical discharge machine according to another embodiment of the invention.

FIG. 4 is a circuit diagram of a green-energy power generator for electrical discharge machine according to an embodiment of the invention.

FIG. 5A is a sequence diagram showing waves of equi-frequency in the circuit of FIG. 4.

FIG. 5B is a sequence diagram showing waves of equi-energy in the circuit of FIG. 4.

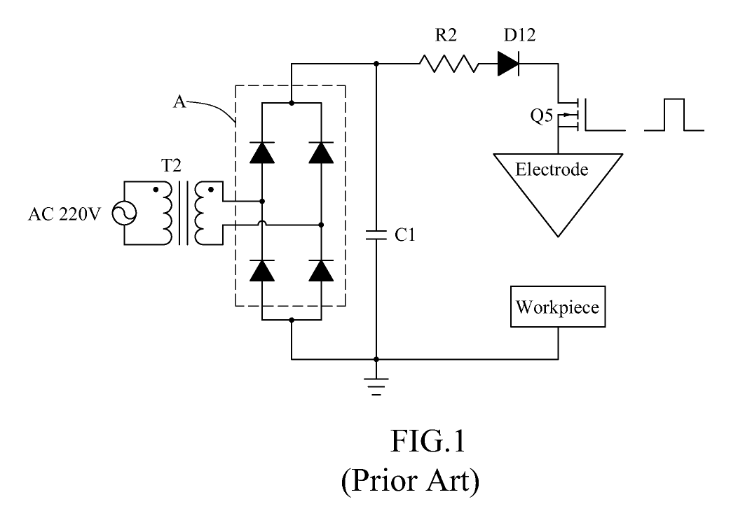

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

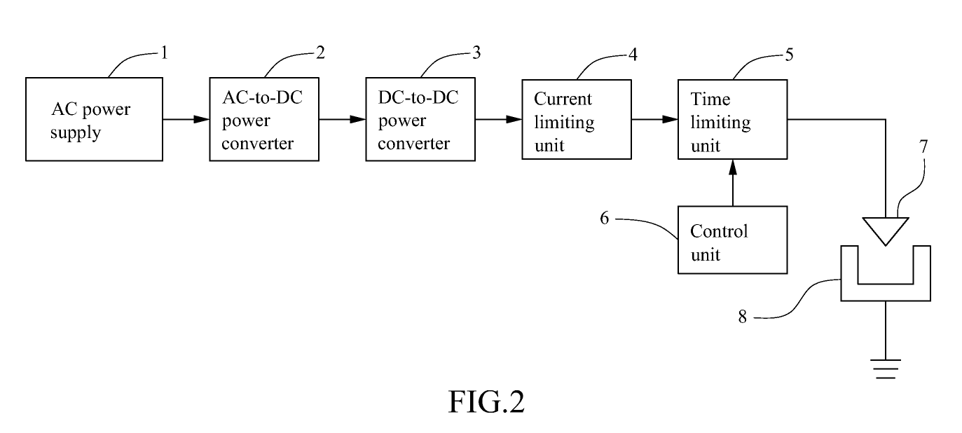

Please refer to FIG. 2, which is a block diagram showing a green-energy power generator for electrical discharge machine according to an embodiment of the invention. In FIG. 2, a green-energy power generator for electrical discharge machine is disclosed, which comprises: an alternating current (AC) power supply 1, for outputting an AC voltage; an AC-to-DC power converter 2, coupled to the AC power supply 1 for converting the AC voltage into a first DC voltage; a DC-to-DC power converter 3, coupled to the AC-to-DC power converter 2, composed of a primary discharge circuit and an arc ignition circuit and being used for converting the first DC voltage into a second DC voltage while enabling the second DC voltage to drop with the increasing of a load; a current limiting unit 4, coupled to the DC-to-DC power converter 3 for limiting the size of current to be outputted therefrom; a time limiting unit 5, coupled to the current limiting unit 4 for limiting the duration of current being outputted therefrom, and thereby, defining a processing time for an electrode 7 upon a workpiece 8; and a control unit 6, coupled to the time limiting unit 5 for controlling the on/off of the time limiting unit 5 according to time pulses provided by the control unit. Generally, when the second DC voltage is dropped by the increasing of a load, it will stilled be maintained no lower than 25V; and the DC-to-DC power converter 3 can be a linear power converter or a switch mode power converter including a buck converter, a boost converter, a buck-boost converter, a C'uk converter, a flyback converter, a forward converter, a half-bridge converter, a full bridge converter, a push-pull converter. Moreover, the current limiting unit 4 is enabled to control at least an electric switch so as to generate currents of various intensities to be outputted therefrom, and can be composed of a metal-oxide-semiconductor field-effect transistor (MOSFET) and a bipolar junction transistor (BJT). It is noted that there can be a plurality of the aforesaid green-energy power generators being parallel-connected with each other and used as a current supply.

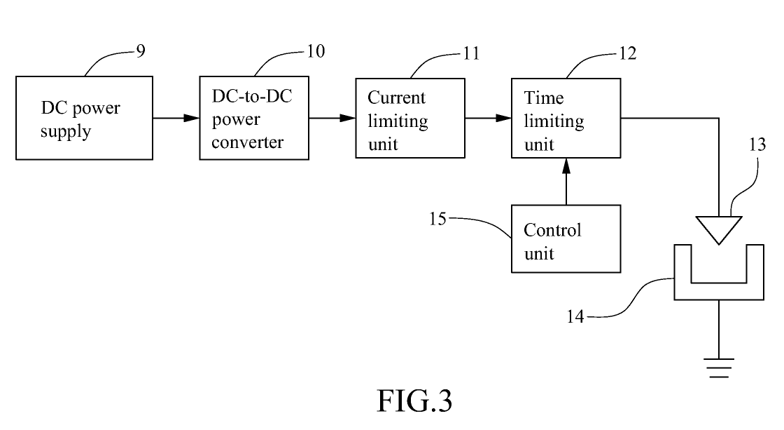

Please refer to FIG. 3, which is a block diagram showing a green-energy power generator for electrical discharge machine according to another embodiment of the invention. In FIG. 3, a green-energy power generator for electrical discharge machine is disclosed, which comprises: an direct current (DC) power supply 9, for outputting a first DC voltage; an DC-to-DC power converter 10, coupled to the DC power supply for converting the first DC voltage into a second DC voltage while enabling the second DC voltage to drop with the increasing of a load; a current limiting unit 11, coupled to the DC-to-DC power converter 10 for limiting the size of current to be outputted therefrom; a time limiting unit 12, coupled to the current limiting unit 11 for limiting the duration of current being outputted therefrom, and thereby, defining a processing time for an electrode 13 upon a workpiece 14; and a control unit 15, coupled to the time limiting unit 12 for controlling the on/off of the time limiting 12 unit according to time pulses provided by the control unit. Similarly, when the second DC voltage is dropped by the increasing of a load, it will stilled be maintained no lower than 25V; and the DC-to-DC power converter 10 can be a linear power converter or a switch mode power converter including a buck converter, a boost converter, a buck-boost converter, a C'uk converter, a flyback converter, a forward converter, a half-bridge converter, a full bridge converter, a push-pull converter. Moreover, the current limiting unit 11 is enabled to control at least an electric switch so as to generate currents of various intensities to be outputted therefrom, and can be composed of a metal-oxide-semiconductor field-effect transistor (MOSFET) and a bipolar junction transistor (BJT). It is noted that there can be a plurality of the aforesaid green-energy power generators being parallel-connected with each other and used as a current supply.

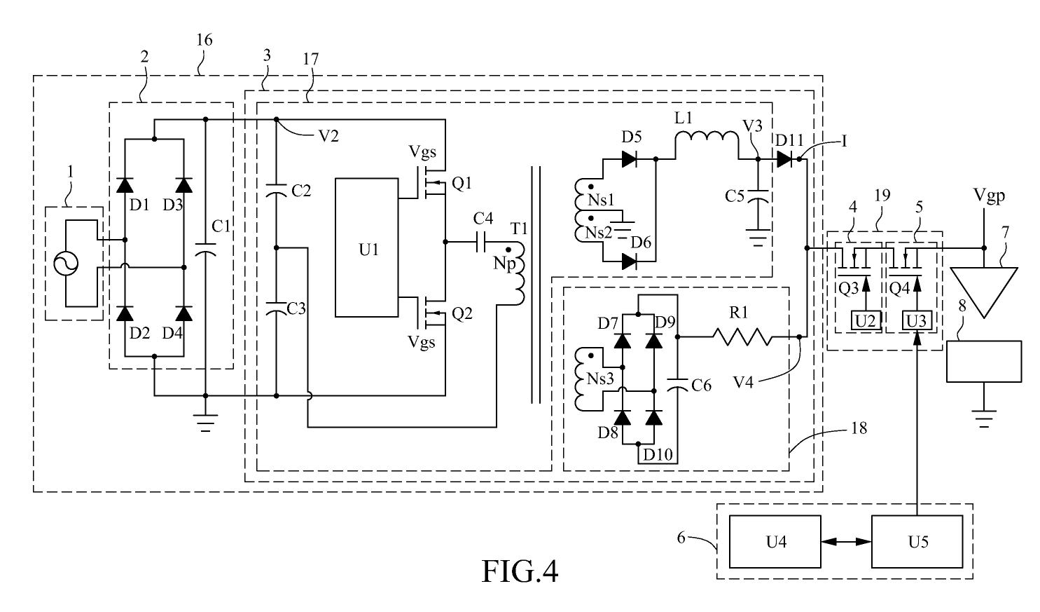

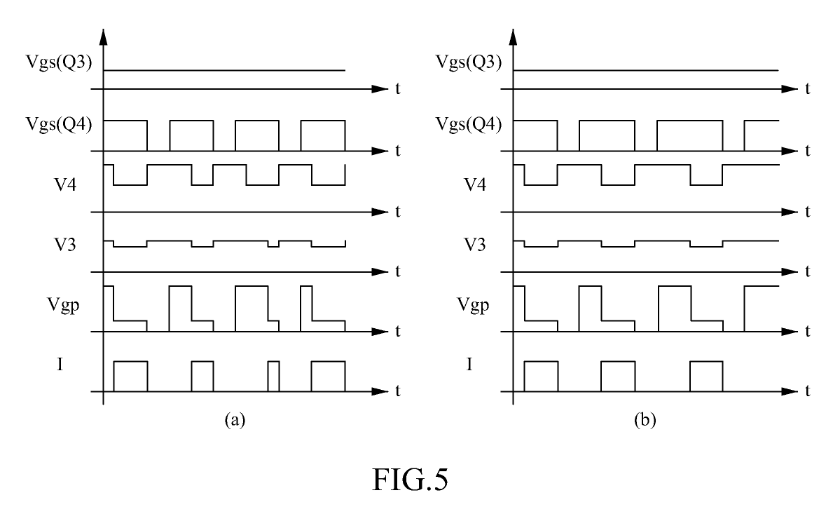

FIG. 4 is a circuit diagram of a green-energy power generator for electrical discharge machine according to an embodiment of the invention and FIG. 5A, 5B are respectively sequence diagrams showing waves of equi-frequency and equi-energy in the circuit of FIG. 4. In FIG. 4 and FIG. 5A B, the green-energy power generator for electrical discharge machine shown in the aforesaid embodiments can be divided into three parts by their functionalities, which are a power converting part 16, a current/time limiting part 19 and the control unit 6.

The first part shown in FIG. 4 is the power converting part 16, in which the DC-to-DC power converter 3 is composed of a primary discharge circuit 17 and an arc ignition circuit 18. The primary discharge circuit 17 is used as the primary power supply for the electrical discharging machine; and the arc ignition circuit 18, being mounted on the secondary winding of a high-frequency transformer T1 in the DC-to-DC power converter 3, is used for generating a high voltage DC to be used for igniting an discharging pulse. In the primary discharge circuit 17, an AC input of the AC power supply 1 is first being fed to a bridge rectifier composed of diodes D1˜D4 to be processed by a full-wave rectification operation, i.e. it is proceeded by a AC-to-DC power converter 2, and then the processed input is filtered by a capacitor C1 for generating a DC of high voltage V2. As soon as the high voltage DC V2 is generated, the control/drive device U1 is activated for subjecting the switches Q1 and Q2 with a voltage for enabling the two switches Q1 and Q2 to perform a high-frequency switching operation according to the signals issued from the control/drive device U1 so as to dividing and thus converting the rectified high voltage DC V2 into high-frequency square wave signals. The high-frequency square wave signals, after being separated and voltage-dropped by the high-frequency transformer T1, are fed to a rectification/filtering circuit disposed at the second side of the high-frequency transformer T1 to be processed by a rectification and low-pass filtering operation for converting the same into a DC of stable voltage V3. It is noted that output of the aforesaid primary discharge circuit 17 is decreased with the increasing of load. Moreover, in the arc ignition circuit 18, the high-frequency AC input is first being full-wave rectified by a full-wave rectification circuit and then being low-pass filtered by a filtering circuit for generating a stable high DC voltage V4. The stable high DC voltage V4 will cause an electrical discharging through the interface of an insulating media, while subjecting the stable high DC voltage to the restriction of the resistor R1 for causing insufficient power output and thus causing the output voltage to drop accordingly. Generally, the operation of the whole power converting part 16 can be described as following: At the beginning of an electrical discharge machining, the arc ignition circuit 18 will first be activated to generate the high DC voltage V4 to be used for causing an electrical discharging through the interface of an insulating media, and the same time during the electrical discharging, the power for enabling the stable high DC voltage V4 is becoming insufficient and thus cause the voltage thereof to drop accordingly. As soon as the voltage is dropped below the output voltage level V3 of the primary discharge circuit 17, the diode D11 will be conducted for allowing the primary discharge circuit 17 to act as a power supply for providing power to the electrical discharge machining while simultaneously feeding energy to the current/time limiting part 19.

The second part shown in FIG. 4 is the current/time limiting part 19, which is composed of a current limiting unit 4 and a time limiting unit 5. The current limiting unit 4 is designed for limiting the size of current for the machining of the electrical discharge machine; and the time limiting unit 5 is designed for limiting the duration of the machining of the electrical discharge machine. In the current/time limiting part 19, first a stable driving voltage is fed to a current-limiting switch Q3 by a voltage stabilizing device U2 to be used for controlling the conductivity of the current-limiting switch Q3 according to the magnitude of the driving voltage. It is noted that the larger the conductivity of the current-limiting switch is, the larger the current outputted from the electrical discharge machine will be; and vice versa. Thereafter, the power switch Q4 is powered by a driving voltage provided from a driving device U3 in a isolate drive manner, by that the duration of the machining of the electrical discharge machine is controlled according to the conductivity of the power switch Q4, such as the On time and OFF time setting for the machining of the electrical discharge machine.

The third part of FIG. 4 is the control unit 6, which is composed of a controller device U4 and a discharge waveform control device U5. The discharge waveform control device U5 is designed for providing equi-energy time pulses or equi-frequency time pulses to each electrical discharging circuit for controlling the conductivity of the corresponding switches and also the ON-OFF duration of the same. In the control unit 6, as soon as machining parameters are inputted into the controller device U4 by users, they will be send to the discharge waveform control device U5 for directing the same to generate time pulse to be used for directing a driving device U3 to control the switch Q4 for emitting a series of rapidly recurring electric arcing discharges accordingly.

From the above description, it is clear that the present invention is designed to provide a green-energy power generator for electrical discharge machine with high power usage efficiency that is capable of reducing unnecessary power waste.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A green-energy power generator for electrical discharge machine, comprising:
an alternating current (AC) power supply, for outputting an AC voltage;
an AC-to-DC power converter, coupled to the AC power supply for converting the AC voltage into a first DC voltage;
a DC-to-DC power converter, coupled to the AC-to-DC power converter for converting the first DC voltage into a second DC voltage while enabling the second DC voltage to drop with the increasing of a load;
a current limiting unit, coupled to the DC-to-DC power converter for limiting the size of current to be outputted therefrom;
a time limiting unit, coupled to the current limiting unit for limiting the duration of current being outputted therefrom, and thereby, defining a processing time for an electrode upon a workpiece; and
a control unit, coupled to the time limiting unit for controlling the on/off of the time limiting unit according to time pulses provided by the control unit.

2. The green-energy power generator for electrical discharge machine of claim 1, wherein the current limiting unit is enabled to control at least an electric switch so as to generate currents of various intensities to be outputted therefrom.

3. The green-energy power generator for electrical discharge machine of claim 1, wherein the current limiting unit is a device selected from the group consisting of:
a metal-oxide-semiconductor field-effect transistor (MOSFET) and a bipolar junction transistor (BJT).

4. The green-energy power generator for electrical discharge machine of claim 1, wherein the DC-to-DC power converter is a device selected from the group consisting of: a linear power converter and a switch mode power converter.

5. The green-energy power generator for electrical discharge machine of claim 4, wherein the switch mode power converter is a device selected from the group consisting of: a buck converter, a boost converter, a buck-boost converter, a C'uk converter, a flyback converter, a forward converter, a half-bridge converter, a full bridge converter, a push-pull converter.

6. The green-energy power generator for electrical discharge machine of claim 1, wherein the DC-to-DC power converter is composed of a primary discharge circuit and an arc ignition circuit.

7. A green-energy power generator for electrical discharge machine, comprising:
an direct current (DC) power supply, for outputting a first DC voltage;
an DC-to-DC power converter, coupled to the DC power supply for converting the first DC voltage into a second DC voltage while enabling the second DC voltage to drop with the increasing of a load;
a current limiting unit, coupled to the DC-to-DC power converter for limiting the size of current to be outputted therefrom;
a time limiting unit, coupled to the current limiting unit for limiting the duration of current being outputted therefrom, and thereby, defining a processing time for an electrode upon a workpiece; and
a control unit, coupled to the time limiting unit for controlling the on/off of the time limiting unit according to time pulses provided by the control unit.

8. The green-energy power generator for electrical discharge machine of claim 7, wherein the current limiting unit is enabled to control at least an electric switch so as to generate currents of various intensities to be outputted therefrom.

9. The green-energy power generator for electrical discharge machine of claim 7, wherein the current limiting unit is a device selected from the group consisting of:
a metal-oxide-semiconductor field-effect transistor (MOSFET) and a bipolar junction transistor (BJT).

10. The green-energy power generator for electrical discharge machine of claim 7, wherein the DC-to-DC power converter is a device selected from the group consisting of: a linear power converter and a switch mode power converter.

11. The green-energy power generator for electrical discharge machine of claim 10, wherein the switch mode power converter is a device selected from the group consisting of: a buck converter, a boost converter, a buck-boost converter, a C'uk converter, a flyback converter, a forward converter, a half-bridge converter, a full bridge converter, a push-pull converter.

12. The green-energy power generator for electrical discharge machine of claim 7, wherein the DC-to-DC power converter is composed of a primary discharge circuit and an arc ignition circuit.
